(19) United States
(12) Patent Application Publication
(10) Pub. No.: US 2025/0002369 A1
(43) Pub. Date: Jan. 2, 2025

(54) METHOD FOR PREPARING A PRECURSOR MATERIAL FOR A LI-CONTAINING CATHODE ACTIVE MATERIAL

(71) Applicant: Umicore, Brussels (BE)

(72) Inventors: Jens Martin PAULSEN, Dunedin (NZ); Kris DRIESEN, Olen (BE); Daniël NELIS, Olen (BE); Randy DE PALMA, Brussels (BE); Kasper LAMBRIGHS, Olen (BE); Jong-Won SHIN, Neuwied (DE)

(21) Appl. No.: 18/703,517

(22) PCT Filed: Oct. 20, 2022
(86) PCT No.: PCT/EP2022/079277

§ 371 Date: Apr. 22, 2024

(30) Foreign Application Priority Data
Oct. 25, 2021 (EP) 21204489.5

(51) Int. Cl. C01G 53/00; H01M 4/02; H01M 4/525

(52) U.S. Cl. CPC C01G 53/44; H01M 4/525; C01P 2002/50; C01P 2004/03; C01P 2004/32; C01P 2004/53; C01P 2004/61; C01P 2004/62; C01P 2006/11; C01P 2006/40; H01M 2004/021; H01M 2004/028

(57) ABSTRACT

Method for preparing a precursor material for a Li-containing cathode active material for a battery, wherein the method comprises a spray pyrolysis step in which a metal oxide is produced by decomposition in a heated chamber of droplets of an aqueous solution, wherein either the metal oxide is a mixed metal oxide comprising the element Ni and one or both of the elements Co and Mn and the aqueous solution is a mixed solution of salts of Ni and of Co and/or Mn or the metal oxide is a Ni oxide and the aqueous solution is a solution of a salt of Ni, characterised in that the method comprises a spray drying step in which an aqueous slurry comprising said metal oxide is spray dried to form said precursor material.

### TECHNICAL FIELD AND BACKGROUND

The present invention concerns a method for preparing a precursor material for a Li-containing cathode active material, i.e. positive electrode active material, and a Li-containing cathode active material from said precursor.

Generally, Li-containing cathode active materials are prepared by first manufacturing a precursor of Co and/or Ni and/or Mn and/or Al, and then reacting such a precursor with a source of Lithium in a furnace.

The precursor is usually a single-element inorganic compound, or a mixture of single-element inorganic compounds or multi-element inorganic compound of the elements Co and/or Ni and/or Mn and/or Al, such as an oxide, hydroxide, or carbonate. The precursor itself usually contains no, or very low, amounts of Li.

A good precursor in an industrial context does not only have properties that allow the preparation of a good quality final product, but also needs to be inexpensive to produce and lend itself to inexpensive further manufacturing steps.

It is known to use spray pyrolysis from a mixed chloride solution to prepare a mixed Ni—Co—Mn oxide as a precursor for Li-containing cathode active materials. See in this respect: ‘Fröhlich et al, New large-scale production route for synthesis of lithium nickel manganese cobalt oxide, J Solid State Electrochem, 21, 3403-3410 (2017).

It is also known from WO 2019/185349 to use spray pyrolysis for preparing mixed Ni—Co—Mn oxide.

However, such known mixed oxides have disadvantages, in particular they cause a relatively high Cl content in the final Li-containing cathode active materials, and a low furnace capacity for the subsequent reaction step with a Li-source due to their low density.

It is also known to use spray pyrolysis from a mixed nitrate solution which includes Li, followed by spray drying, to prepare LiMn₂O₄ usable as Li-containing cathode active material. This is disclosed in TANIGUCHI at al “Synthesis of spherical LiMn₂O₄ microparticles by a combination of spray pyrolysis and drying method”, POWDER TECHNOLOGY, Vol. 181, no. 3, 29 Jan. 2008, pages 228-236.

However, this produces gaseous NO and NO₂ as decomposition products. This is undesirable because NO and NO₂ are highly polluting gasses in the atmosphere, causing both smog and acid rain. Such a method therefore requires very elaborate and expensive removal of NO and NO₂ from the gas resulting from the pyrolysis.

It is also known to use spray pyrolysis from a mixed chloride solution which includes Li, followed by spray drying, to prepare lithiated metal oxide directly usable as Li-containing cathode active material. This is disclosed in CN 104934572. However, in such a method results in a high Cl content in the final product, making the products less suitable to be used in batteries.

### SUMMARY OF THE INVENTION

The present invention aims to avoid and/or reduce these and other disadvantages and therefore concerns a method for preparing a precursor material for a Li-containing cathode active material for a battery, wherein the method comprises a spray pyrolysis step in which a metal oxide is produced by decomposition in a heated chamber of droplets of an aqueous solution, wherein the method comprises a spray drying step in which an aqueous slurry comprising said metal oxide, either directly from the spray pyrolysis step or after one or more intermediate processing steps, is spray dried to form said precursor material, wherein the metal oxide has one of the following characteristics:
1) the metal oxide is a mixed metal oxide comprising the element Ni and one or both of the elements Co and Mn and the aqueous solution is a mixed solution of salts of Ni and of Co and/or Mn;
2) the metal oxide is a Ni oxide and the aqueous solution is a solution of a salt of Ni;
3) the metal oxide is a Mn oxide and the aqueous solution is a solution of a salt of Mn.

In chemistry, a mixed oxide is a name for an oxide compound that contains cations of more than one chemical element or cations of a single element in several states of oxidation.

In the present document the first alternative in this definition is intended.

Alternatively a mixed metal oxide may be defined as a metal oxide in which each particle of the metal oxide contains all of the metal elements that are present in the metal oxide.

As a mixed metal oxide is not considered a mixture of single-metal oxides but only an oxide compound containing cations of two or more different metal elements.

A mixed solution of salts means a solution in which salts of different metal elements are present in the same solvent, irrespective of whether an explicit mixing step has taken place.

Various embodiments according to the present invention are disclosed in the claims as well as in the description. The embodiments and examples recited in the claims and in the description are mutually freely combinable unless otherwise explicitly stated. Throughout the entire specification, if any numerical ranges are provided, the ranges include also the endpoint values unless otherwise explicitly stated.

The present invention concerns the following preferred embodiments:

In the spray drying step the bulk density of the metal oxide is significantly increased, so that the capacity of a furnace used for the reaction of the precursor material with Li is improved.

In a preferred variant said salt or salts are chlorides. They are cheap to obtain and highly soluble. Also, they can be easily recycled.

In a preferred variant the method comprises a slurry preparation step in which particles of said metal oxide, either directly from the spray pyrolysis step or after one or more intermediate processing steps, are mixed with water to prepare said aqueous slurry.

In a preferred variant the method comprises a washing step in which a mixture is prepared of the metal oxide, either directly from the spray pyrolysis step or after one or more intermediate processing steps, and water in a ratio (weight of water)/(weight of metal oxide) of at least 0.1, and preferably at least 0.5, wherein this mixture is filtered, or centrifuged, or decanted to recover the metal oxide, whereby the washing steps takes place before the slurry preparation step.

In this washing step residual anions, in particular chlorides, in the metal oxide can be removed, because they are soluble in the water. The skilled person will realise that the amount of water to be used depends on the anion content that is desired after the washing step.

In a preferred variant the method comprises a size reduction step in which the metal oxide, either directly from the spray pyrolysis step or after one or more intermediate processing steps, undergoes a particle size reduction, whereby the size reduction step takes place before the spray drying step.

This improves the homogeneity of the precursor material that is produced, and also allows the increased capacity of the spray drying step.

In a preferred variant the size reduction step takes place on metal oxide which is wet with water. In case a preceding wet step is present, e.g. the abovementioned washing step, this avoids intermediate drying of the metal oxide. It also reduces dust creation.

In a preferred variant the median particle size D50 of the particles of said metal oxide in the aqueous slurry is between 10 nm and 1000 nm so that the content of metal oxide that can be obtained in the aqueous slurry can be optimal.

In a preferred variant the precursor material comprises spherical particles, wherein the precursor material has a bulk density of at least 1.0 g/cm³, preferably of at least 1.3 g/cm³, more preferably of at least 1.4 g/cm³. A spherical particle has a roundness ratio of at least 0.5 when examined by a microscope to a cross-sectional image. It is calculated as the ratio between the area of the particle and the area of the disk having maximum diameter of the particle.

The spherical particles preferably have a median particle diameter D50 which is at least 2 μm and which is at most 50 μm in order to obtain a good balance between ease of handling and reaction speed with Li during the subsequent processing steps.

The metal oxide preferably has a molar content y of Mn, a molar content z of Co, a molar content b of Ni, a molar content a of A, wherein A is any metal element other than Li, Ni, Mn, and Co, wherein
0.20≤b/(y+z+b+a)≤1.00, for example 0.30, 0.40, 0.50, 0.60, 0.70, 0.80, or 0.90,
0≤y/(y+z+b+a)≤0.80, for example 0.10, 0.20, 0.30, 0.40, 0.50, 0.60, or 0.70,
0≤z/(y+z+b+a)≤0.60, for example 0.10, 0.20, 0.30, 0.40, or 0.50, and
0≤a/(y+z+b+a)≤0.10, for example 0.01, 0.02, 0.03, 0.04, 0.05, 0.06, 0.07, 0.08 or 0.09.

More preferably 0.30≤b/(y+z+b+a)≤1.00, and even more preferably 0.45≤b/(y+z+b+a)≤1.00.

More preferably the metal oxide is a mixed metal oxide, wherein 0.30≤b/(y+z+b+a)≤0.95 and 0.04≤z/(y+z+b+a)≤0.60, and even more preferably wherein 0.45≤b/(y+z+b+a)≤0.90 and 0.04≤z/(y+z+b+a)≤0.35.

### BRIEF DESCRIPTION OF THE FIGURES

FIG. 1. CS-SEM image of EX1.2

### DETAILED DESCRIPTION

In the following detailed description, preferred embodiments are described so as to enable the practice of the invention. Although the invention is described with reference to these specific preferred embodiments, it will be understood that the invention is not limited to these preferred embodiments. The invention includes numerous alternatives, modifications and equivalents that are apparent from consideration of the following detailed description and accompanying drawings.

### A) CS-SEM (Cross Section Scanning Electron Microscope) Analysis

Cross-sections of transition metal oxide precursor, i.e. the precursor material, as described herein are prepared by an ion beam cross-section polisher (CP) instrument JEOL (IB-0920CP). The instrument uses argon gas as beam source.

To prepare the specimen, a small amount of a transition metal oxide precursor powder was mixed with a resin and hardener, then the mixture was heated for 10 minutes on a hot plate. After heating, it was placed into the ion beam instrument for cutting and the settings were adjusted in a standard procedure, with a voltage of 6.5 kV for a 3 hours duration.

The morphology of transition metal oxide precursor was analyzed by a Scanning Electron Microscopy (SEM) technique. The measurement was performed with a JEOL JSM 7100F (https://www.jeolbenelux.com/JEOL-BV-News/jsm-7100f-thermal-field-emission-electron-microscope) under a high vacuum environment of 9.6×10⁻⁵ Pa at 25° C.

### B) Particle Size Analysis

The particle size distribution (PSD) of the transition metal oxide precursor powder, i.e. the precursor material, was measured by laser diffraction particle size analysis using a Malvern Mastersizer 3000 with a Hydro MV wet dispersion accessory (https://www.malvernpanalytical.com/en/products/product-range/mastersizer-range/mastersizer-3000 #overview) after having dispersed each of the powder samples in an aqueous medium. In order to improve the dispersion of the powder, sufficient ultrasonic irradiation and stirring was applied, and an appropriate surfactant was introduced. Median size D50 is defined as the particle size at 50% of the cumulative volume % distributions obtained from the Malvern Mastersizer 3000 with Hydro MV measurements.

### C) Bulk Density

The bulk density of the precursor material powder is determined by measuring the mass of the powder flowed into the graduated cylinder with a specific volume. The precursor bulk density is calculated according to:

$$powder bulk density = \frac{mass of powder inside graduated cyclinder ( gram )}{volume of graduated cylinder ( {cm}^{3} )}$$

### D) Carbon Analyzer

The content of carbon of the positive electrode active material powder is measured by Horiba Emia-Expert carbon/sulfur analyzer. 1 gram of example or comparative example is placed in a ceramic crucible in a high frequency induction furnace. 1.5 gram of tungsten and 0.3 gram of tin as accelerators are added into the crucible. The powder is heated at a programmable temperature wherein gases produced during the combustion are then analyzed by Infrared detectors. The analysis of CO₂ and CO determines carbon concentration.

### E) ICP Analysis

The amount of metal elements, e.g. Ni, Mn, and Co, in the precursor is measured with the Inductively Coupled Plasma (ICP) method by using an Agillent ICP 720-ES (Agilent Technologies). 2 grams of powder sample is dissolved into 10 μmL of high purity hydrochloric acid (at least 37 wt. % of HCl with respect to the total weight of solution) in an Erlenmeyer flask. The flask is covered by a glass and heated on a hot plate at 380° C. until complete dissolution of the precursor. After being cooled to room temperature, the solution of the Erlenmeyer flask is poured into a 250 μmL volumetric flask. Afterwards, the volumetric flask is filled with deionized water up to the 250 μmL mark, followed by complete homogenization. An appropriate amount of solution is taken out by pipette and transferred into a 250 μmL volumetric flask for the 2nd dilution, where the volumetric flask is filled with internal standard and 10% hydrochloric acid up to the 250 μmL mark and then homogenized. Finally, this 50 μmL solution is used for ICP measurement.

The invention is further illustrated by the following (non-limitative) examples:

### Example 1.1: Mixed Metal Oxides

A precursor product was obtained through a spray pyrolysis and spray drying process running as follows:
1) Feed solution preparation: A mixed feed solution comprising NiCl₂, MnCl₂, and CoCl₂ solution in water with total concentration of 110 gram/L having Ni, Mn, and Co in a ratio Ni:Mn:Co of 0.6:0.2:0.2 was prepared.
2) Spray pyrolysis: This feed solution was sprayed in the form of droplet into a heated chamber at 650° C. so as to decompose the salt and form mixed metal oxide powder. Chamber volume was approximately 8.8 μm³ and feed rate was 30 L/hour.
3) Washing: The mixed metal oxide powder was washed with water (25 wt % solid content) followed by filtration to reduce the chloride content.
4) Slurry formulation: Slurry was prepared by mixing the washed product from step 3) with dispersant (Dolapix CA, Zschimmer & Schwarz, DE) so as to have a 70 wt % solid content and 2 wt % dispersant in water.
5) Wet bead mill: The prepared slurry was wet bead milled with specific milling energy of 1300 kWh/T. Milling media was Y stabilized ZrO₂ bead (YSZ) with 1 mm diameter. The milled particle D50 was 0.28 μm.
6) Spray drying: The milled slurry was spray dried by two fluid nozzles with inlet temperature of 170° C. and outlet temperature of 100° C. The product of this step was precursor powder labelled as EX1.1.

EX1.1 powder has bulk density of 1.8 g/cm³ and carbon content of 0.7 wt. % with respect to the total weight of the powder.

The intermediate product after step 2 had a bulk density of 0.31 g/cm³.

### Example 1.2: Heated Mixed Metal Oxides

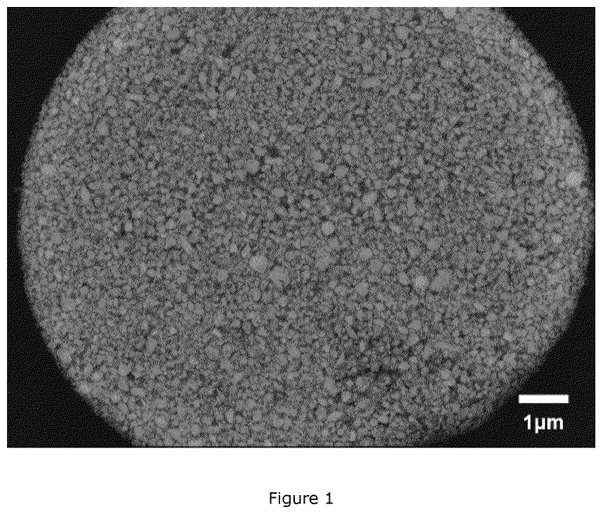

EX1.1 was heated in a furnace at 500° C. for 5 h under oxygen atmosphere to produce EX1.2 powder having D50 of 12.6 μm. The CS-SEM image of EX1.2 particle is shown in FIG. 1. The carbon content was 0.012 wt. % with respect to the total weight of EX1.2.

### Example 1.3: Mixed Metal Bearing Positive Electrode Active Material

EX1.3 was obtained through a solid-state reaction between a lithium source and a transition metal-based precursor running as follows:
1) Mixing: the precursor powder EX1.2 and LiOH as a lithium source were homogenously mixed with a lithium to metal Me (Li/Me) ratio of 1.05 in an industrial blending equipment to obtain a mixture (Me=Ni, Mn, Co).
2) Heating: the mixture from Step 1) was heated at 840° C. for 15 hours under an oxygen atmosphere. The heated powder was crushed, classified, and sieved so as to obtain a lithiated product labelled as EX1.3.

### Example 2.1: Nickel Oxide

EX2.1 was prepared according to the same method as EX1.1 except that the feed solution in the step 1) only comprises NiCl₂. The milled particle D50 was 0.25 μm.

EX2.1 is a NiO precursor powder having bulk density of 1.5 g/cm³.

### Example 2.2: Heated Nickel Oxides

EX2.1 was heated in a furnace at 500° C. for 5 h under oxygen atmosphere to produce EX2.2 powder having D50 of 12.0 μm. The carbon content was 0.015 wt. % with respect to the total weight of EX2.2.

### Example 2.3: Nickel Bearing Positive Electrode Active Material

EX2.3 was obtained through a solid-state reaction between a lithium source and a transition metal-based precursor running as follows:
1) Mixing: the precursor powder EX2.2 and LiOH as a lithium source were homogenously mix with a lithium to metal Me (Li/Me) ratio of 1.05 in an industrial blending equipment to obtain a mixture (Me=Ni, Mn, Co).
2) Heating: the mixture from Step 1) was heated at 750° C. for 15 hours under an oxygen atmosphere. The heated powder was crushed, classified, and sieved so as to obtain a lithiated product labelled as EX2.3.

1-15. (canceled)

16. A method for preparing a precursor material for a Li-containing cathode active material for a battery, wherein the method comprises
a spray pyrolysis step in which a metal oxide is produced by decomposition in a heated chamber of droplets of an aqueous solution, wherein
either the metal oxide is a mixed metal oxide comprising the element Ni and one or both of the elements Co and Mn and the aqueous solution is a mixed solution of salts of Ni and of Co and/or Mn
or the metal oxide is a Ni oxide and the aqueous solution is a solution of a salt of Ni,
or the metal oxide is a Mn oxide and the aqueous solution is a solution of a salt of Mn, characterized in that the method comprises a drying step in which an aqueous slurry comprising said metal oxide is dried to form said precursor material.

17. The method according to claim 16, wherein the drying step is a spray drying step in which the aqueous slurry is spray dried to form said precursor material.

18. The method according to claim 16, wherein the metal oxide is a mixed metal oxide comprising the element Ni and one or both of the elements Co and Mn, and the aqueous solution is a mixed solution of salts of Ni and of Co and/or Mn.

19. The method according to claim 16, characterized in that said salt is a chloride or said salts are chlorides.

20. The method according to claim 16, wherein the precursor material is heated at the temperature of at least 300° C. and at most 1000° C. to produce a heat-treated precursor material.

21. The method according to claim 16, wherein the method further comprises a washing step in which a mixture is prepared of the metal oxide and water in a ratio (weight of water)/(weight of metal oxide) of at least 0.1, wherein this mixture is filtered, or centrifuged, or decanted to recover the metal oxide, whereby the washing steps takes place before the slurry preparation step.

22. The method according to claim 16, wherein the method further comprises a size reduction step in which the metal oxide undergoes a particle size reduction, whereby the size reduction step takes place before the spray drying step.

23. The method according to claim 22, wherein the size reduction step takes place on the metal oxide, which is wet with water.

24. The method according to claim 16, wherein the concentration of said metal oxide in the aqueous slurry is at least 30 wt. %.

25. The method according to claim 16, wherein the median particle size D50 of the particles of said metal oxide in the aqueous slurry have a first particle size distribution as determined by laser diffraction, wherein said first particle size distribution has a first D50 of at most 0.60 μm.

26. The method according to claim 16, wherein the precursor material consists of spherical particles, wherein the precursor material has a bulk density of at least 1.0 g/cm³.

27. The method according to claim 26, wherein the spherical particles have a second particle size distribution as determined by laser diffraction, wherein said second particle size distribution has a second D50 which is at least 2 μm.

28. The method according to claim 26, wherein the spherical particles have a second particle size distribution as determined by laser diffraction, wherein said second particle size distribution has a second D50 which is at most 25 μm.

29. The method according to claim 16, wherein the metal oxide has a molar content y of Mn, a molar content z of Co, a molar content b of Ni, a molar content a of A, wherein A is any metal element other than Li, Ni, Mn, and Co, wherein:
0.20≤b/(y+z+b+a)≤1.00,
0≤y/(y+z+b+a)≤0.80,
0≤z/(y+z+b+a)≤0.60 and
0≤a/(y+z+b+a)≤0.10.

30. The method according to claim 16, wherein the metal oxide has a molar content y of Mn, a molar content z of Co, a molar content b of Ni, a molar content a of A, wherein A is any metal element other than Li, Ni, Mn, and Co, wherein 0.30≤b/(y+z+b+a)≤0.95 and 0.05≤(y+z+a)/(y+z+b+a)≤0.70.
